(19) United States
(12) Patent Application Publication
(10) Pub. No.: US 2021/0097316 A1
(43) Pub. Date: Apr. 1, 2021

(54) VEHICLE INTERIOR DETECTION DEVICE, VEHICLE INTERIOR DETECTION METHOD, AND NON-TRANSITORY STORAGE MEDIUM

(71) Applicant: TOYOTA JIDOSHA KABUSHIKI KAISHA, Aichi-ken (JP)

(72) Inventors: Yukinori II, Toyota-shi (JP); Takeo MORIAI, Nagakute-shi (JP); Kazunori MITOMI, Toyota-shi (JP); Yasuyuki KAMEZAKI, Toyota-shi (JP); Kenta MIYAHARA, Toyota-shi (JP)

(21) Appl. No.: 16/992,130

(22) Filed: Aug. 13, 2020

(30) Foreign Application Priority Data
Sep. 27, 2019 (JP) 2019-177717

(51) Int. Cl. G06K 9/00; B60R 11/04; G06T 7/00

(52) U.S. Cl. CPC G06K 9/00832; B60R 11/04; G06T 2207/30268; B60R 2300/8006; G06T 7/001

(57) ABSTRACT

A vehicle interior detection device, comprises a memory, and a processor connected to the memory. The processor is configured to receive a first signal at a start-of-use of a vehicle, receive a second signal at an end-of-use of the vehicle, capture a first image of an interior of the vehicle in response to receiving the first signal, capture a second image of the interior of the vehicle in response to receiving the second signal, and detect at least one of damage in the interior of the vehicle or a blemish in the interior of the vehicle by comparing image data of the first image with image data of the second image.

### CROSS-REFERENCE TO RELATED APPLICATION

This application is based on and claims priority under 35 USC 119 from Japanese Patent Application No. 2019-177717 filed on Sep. 27, 2019, the entire disclosure of which is incorporated by reference herein.

### BACKGROUND

### Technical Field

The present disclosure relates to a vehicle interior detection device, a vehicle interior detection method and a non-transitory storage medium.

### Background

For example, in Japanese Patent Application Laid-Open No. 2002-149797, a technique is disclosed of, in a vehicle rental system, a staff member or a user at a dispatch place before and after use capturing an image of a vehicle, comparing the image with image data before boarding, and checking whether or not there is a scratch and dirt.

In the vehicle rental system disclosed in Japanese Patent Application Laid-Open No. 2002-149797, a person must take an image of the vehicle. If a person forgets to take the image, the presence or absence of a scratch, dirt, and the like may be difficult to confirm.

### SUMMARY

The present disclosure provides a vehicle interior detection device and a vehicle interior detection method and a non-transitory storage medium which can stably confirm the presence or absence of damage and blemishes generated during use of a vehicle.

A vehicle interior detection device according to at least one aspect includes a communication unit that receives a signal at a start-of-use of a vehicle and a signal at an end-of-use of the vehicle. The vehicle interior detection device further includes a start-of-use imaging unit that captures an image of an entirety of an interior of the vehicle in response to receiving the signal at the start-of-use of the vehicle from the communication unit. The vehicle interior detection device further includes an end-of-use imaging unit that captures an image of the entirety of the interior of the vehicle in response to receiving the signal at the end-of-use of the vehicle from the communication unit. The vehicle interior detection device further includes a change detection unit that detects at least one of damage in the interior of the vehicle or a blemish in the interior of the vehicle, due to use of the vehicle, by comparing the image data of the interior of the vehicle which is captured by the start-of-use imaging unit with image data of the interior of the vehicle which is captured by end-of-use imaging unit.

In the vehicle interior detection device according to at least one aspect, the signal at the start-of-use of the vehicle and the signal at the end-of-use of the vehicle are received by the communication unit. An image of the entirety of the interior of the vehicle is captured by the start-of-use imaging unit in response to the communication unit receiving the signal at the start-of-use of the vehicle. On the other hand, an image of the entirety of the interior of the vehicle is captured by the end-of-use imaging unit in response to the communication unit receiving the signal at the end-of-use of the vehicle. Further, the change detection unit detects at least one of the damage in the interior of the vehicle or a blemish in the interior of the vehicle by comparing the image data of the interior of the vehicle which is captured by the start-of-use imaging unit with image data of the interior of the vehicle which is captured by the end-of-use imaging unit. As a result, obtaining information on at least one of the damage or a blemish generated during use of the vehicle is possible.

In addition, since a person, such as a user, is not required to take an image of the vehicle interior, an image of the vehicle interior can be reliably taken at the start-of-use and at the end-of-use.

In the vehicle interior detection device according to at least one aspect, the change detection unit further detects an item left behind in the interior of the vehicle.

In the vehicle interior detection device according to at least one aspect, when a user leaves an item in a vehicle or the like which is used in a car sharing service, the change detection unit can detect the item that has been left behind.

In the vehicle interior detection device according to at least one aspect, the start-of-use imaging unit and the end-of-use imaging unit capture an image of the entirety of the interior of the vehicle by a camera that is disposed at a central portion, in a plan view, of a ceiling of the interior of the vehicle.

In the vehicle interior detection device according to at least one aspect, since the camera is disposed at a central portion of the ceiling of the interior of the vehicle, the entirety of the interior of the vehicle can be imaged with one camera.

In the vehicle interior detection device according to at least one aspect, a driver monitoring camera, which captures an image of the vehicle interior including a driver during driving, is provided at a vehicle front portion in the interior of the vehicle, and the start-of-use imaging unit and the end-of-use imaging unit capture an image of the entirety of the interior of the vehicle by the driver monitoring camera.

In the vehicle interior detection device according to at least one aspect, an image of the entirety of the interior of the vehicle is captured at the start-of-use and at the end-of-use using the driver monitoring camera for capturing an image of the driver during driving. As a result, there is no need to separately prepare a dedicated camera for detecting damage and blemishes in the interior of the vehicle.

In the vehicle interior detection device according to at least one aspect, a during-use imaging unit that captures an image of the entirety of the interior of the vehicle during from when use of the vehicle starts to when use of the vehicle ends is included, and the change detection unit detects at least one of the damage in the interior of the vehicle or a blemish in the interior of the vehicle, due to use of the vehicle, by comparing the image data of the interior of the vehicle which is captured by the start-of-use imaging unit with image data of the interior of the vehicle which is captured by the end-of-use imaging unit, and also comparing the image data of the interior of the vehicle which is captured by the start-of-use imaging unit with image data of the interior of the vehicle which is captured by the during-use imaging unit.

In the vehicle interior detection device according to at least one aspect, the interior of the vehicle is imaged by the during-use imaging unit even during use of the vehicle. Further, at least one of the damage in the interior of the vehicle or a blemish in the interior of the vehicle, due to use of the vehicle, is detected by comparing the image data of the vehicle interior which is captured by the start-of-use imaging unit with image data of the interior of the vehicle which is captured by the during-use imaging unit. As a result, accurately obtaining information on at least one of the damage and blemishes generated during use of the vehicle is possible.

A vehicle interior detection system according to at least one aspect includes the vehicle interior detection device and a server that can send and receive communications with the vehicle interior detection device, via a network, by the communication unit, the communication unit transmitting, to the server, information regarding a change in at least one of the damage in the interior of the vehicle detected by the change detection unit or a blemish in the interior of the vehicle detected by the change detection unit.

In the vehicle interior detection system according to at least one aspect, the vehicle interior detection device and the server can communicate with each other, via the network, by the communication unit. Further, the communication unit transmits, to the server, information regarding a change in at least one of the damage in the interior of the vehicle or a blemish in the interior of the vehicle. As a result, information regarding a change in at least one of the damage of the vehicle or a blemish of the vehicle can be accumulated in the server.

In the vehicle interior detection system according to at least one aspect, a reservation device that is configured to transmit, via the server, a signal of a ride reservation to the vehicle is included, and the reservation device notifies a user of the information regarding a change in at least one of the damage in the interior of the vehicle detected by the change detection unit or a blemish in the interior of the vehicle detected by the change detection unit.

The vehicle interior detection system according to at least one aspect includes a reservation device, and the reservation device transmits, via the server, a signal of a ride reservation to the vehicle. Further, the reservation device notifies the user of information regarding a change in at least one of the damage of the interior of the vehicle or a blemish of the interior of the vehicle. As a result, information on at least one of the damage of the interior of the vehicle or a blemish of the interior of the vehicle can be notified at the time of reservation of the vehicle, and occurrence of trouble can be suppressed.

As described above, according to the vehicle interior detection device according to the present disclosure, stably checking for the presence or absence of damage or a blemish or the like generated during use of the vehicle is possible.

### BRIEF DESCRIPTION OF THE DRAWINGS

Exemplary embodiments of the present invention will be described in detail based on the following figures, wherein:

FIG. 1 is a schematic diagram of a vehicle interior detection system according to at least one exemplary embodiment;

FIG. 2 is a side view of a main part of the vehicle in at least one embodiment;

FIG. 3 is a block diagram of a hardware configuration of the vehicle interior detection device according to at least one embodiment;

FIG. 4 is a block diagram of a hardware configuration of the reservation device in at least one embodiment;

FIG. 5 is a block diagram of a functional configuration of the vehicle interior detection device according to at least one embodiment;

FIG. 6 is a block diagram of a functional configuration of the reservation device in at least one embodiment;

FIG. 7 is a flowchart of a flow of a change detection process according to at least one embodiment;

FIG. 8 is a side view corresponding to FIG. 2 of a main part of a vehicle in at least one embodiment; and

FIG. 9 is a block diagram of a functional configuration of the vehicle interior detection device according to at least one embodiment;

### DETAILED DESCRIPTION

Explanation follows regarding a vehicle interior detection system 10 according to at least one embodiment, with reference to the drawings. Note that the dimensional ratios in the drawings are exaggerated for convenience of explanation, and there are cases in which the dimensional ratios differ from actual dimension ratios.

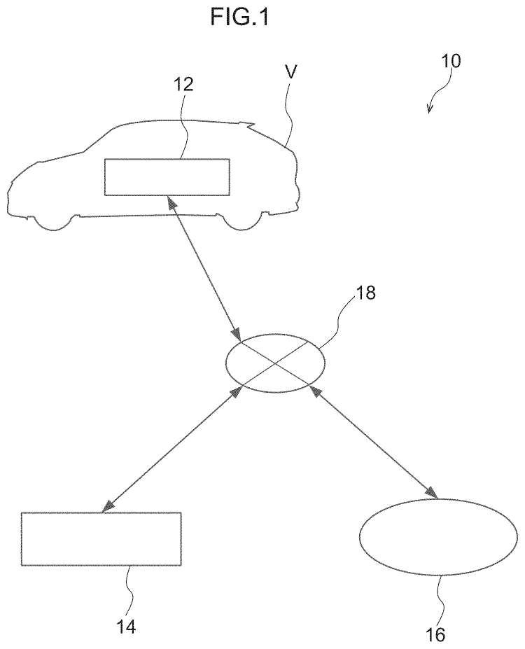

As shown in FIG. 1, the vehicle interior detection system 10 is configured to include a vehicle interior detection device 12, a reservation device 14, and a server 16. Further, the vehicle interior detection device 12, the reservation device 14, and the server 16 are connected by a predetermined network 18.

The vehicle interior detection device 12 of at least one embodiment is provided in the vehicle V. Further, the vehicle V of at least one embodiment is, for example, a vehicle used in a car sharing service. The vehicle V can be used when the user makes a reservation using the reservation device 14.

Information on available vehicles V and the like is accumulated on the server 16, and is periodically updated. Further, information on changes in scratches and dirt in the vehicle interior is accumulated on the server 16. This process is explained in detail later.

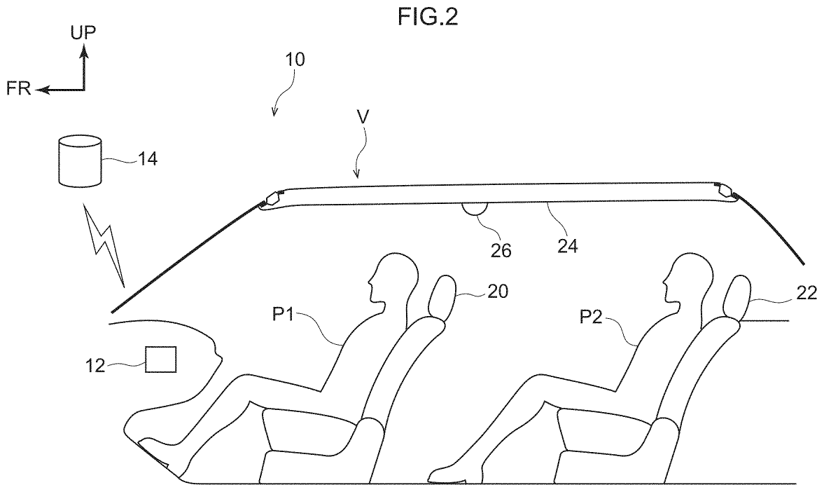

As shown in FIG. 2, seats 20 and 22 on which occupants P1 and P2 can sit are arranged in the cabin of the vehicle V. An indoor camera 26 is provided on the ceiling 24 in the vehicle interior, and the indoor camera 26 is located at a central portion in the vehicle longitudinal direction in the vehicle interior. The indoor camera 26 is located at the center in the vehicle width direction. In other words, the indoor camera 26 is disposed at the center of the vehicle V in a plan view.

The indoor camera 26 of at least one embodiment is a so-called omnidirectional camera, and is configured to be able to capture an image of the entire vehicle interior, but is not limited to this. For example, a configuration may be employed in which the entire interior of the vehicle can be imaged by causing the indoor camera 26 to scan.

(Hardware Configuration of Vehicle Interior Detection Device 12 According to at Least One Embodiment)

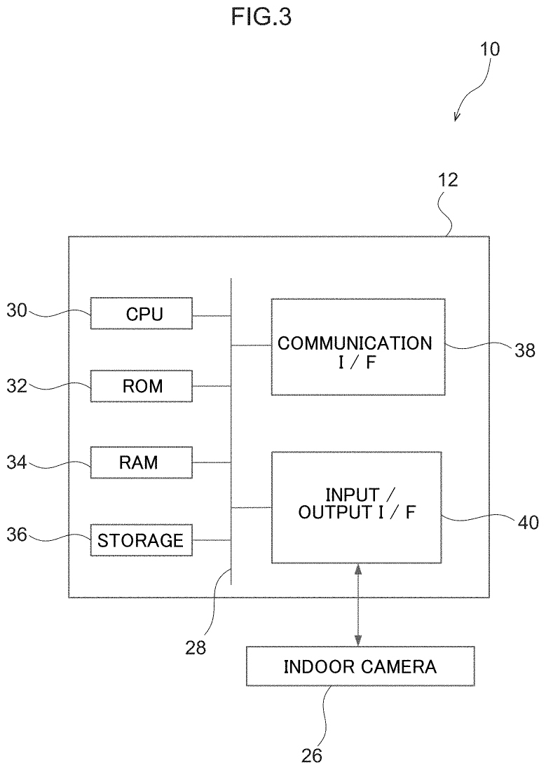

FIG. 3 is a block diagram of a hardware configuration of the vehicle interior detection device 12. As shown in FIG. 3, the vehicle interior detecting device 12 includes a CPU, that is, a central processing unit, a processor 30, a ROM, that is, a read only memory 32, a RAM, that is, a random access memory 34, a storage 36, a communication interface 38, and an input/output interface 40. Each of these components is connected together so as to be capable of mutual communication through a bus 28.

As a processor, the CPU 30 is a central computation processing unit that executes various programs and controls the respective sections. That is, the CPU 30 reads a program from the ROM 32 as a memory or the storage 36 as a memory, and executes the program using the RAM 34 as a work area. The CPU 30 controls the various configurations and performs various computation processing according to the program recorded in the ROM 32 or the storage 36.

The ROM 32 stores various programs and various data. The RAM 34 acts as a workspace for temporary storage of programs and data. The storage 36 is configured by an HDD, that is, a Hard Disk Drive, or an SSD, that is, a Solid State Drive, and various types of programs including the operating system, and various types of data are stored therein. In at least one embodiment, the ROM 32 or the storage 36 stores a change detection program for detecting a change in scratches and dirt in the vehicle interior.

The communication interface 38 is an interface through which the cabin detection device 12 communicates with the reservation device 14, the server 16, and other devices, for example, standards such as registered trademark Ethernet, FDDI, and registered trademark Wi-Fi, being used.

The indoor camera 26 is connected to the input/output interface 40. The indoor camera 26 is configured to receive a signal from the vehicle interior detection device 12 and to image the interior of the vehicle at a predetermined timing.

(Hardware Configuration of Reservation Device 14 According to at Least One Embodiment)

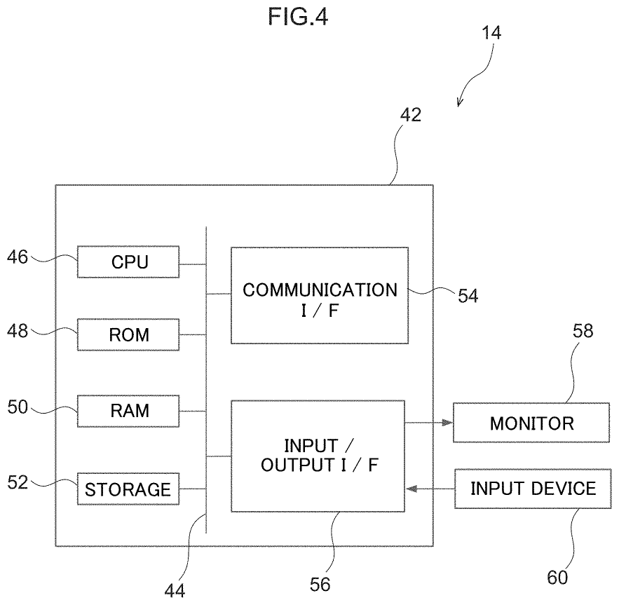

FIG. 4 is a block diagram of a hardware configuration of the reservation device 14. As shown in FIG. 4, the control unit 42 of the reservation device 14 is configured to include a CPU 46, a ROM 48, a RAM 50, a storage 52, a communication interface 54, and an input/output interface 56. Each of these components is connected together so as to be capable of mutual communication through a bus 44.

As a processor, the CPU 46 is a central computation processing unit that executes various programs and controls the respective sections. That is, the CPU 46 reads a program from the ROM 48 as a memory or the storage 52 as a memory, and executes the program using the RAM 50 as a work area. The CPU 46 controls the various configurations and performs various computation processing according to the program recorded in the ROM 48 or the storage 52.

The ROM 48 stores various programs and various data. The RAM 50 acts as a workspace for temporary storage of programs and data. The storage 52 is configured by an HDD, that is, a Hard Disk Drive, or an SSD, that is, a Solid State Drive, and various types of programs including the operating system, and various types of data are stored therein.

The communication interface 54 is an interface through which the reservation device 14 communicates with the vehicle interior detection device 12, the server 16, and other devices, for example, standards such as registered trademark Ethernet, FDDI, and registered trademark Wi-Fi, being used.

A monitor 58 and an input device 60 are connected to the input/output interface 56. The monitor 58 is a display device for displaying various information to the user. The monitor 58 displays, for example, a list of available vehicles and information on scratches and dirt in the vehicle interior of each vehicle. The input device 60 is a device for a user to perform an input, and is configured to include a keyboard, a mouse, a touch panel, and the like.

(Functional Configuration of Vehicle Interior Detection Device 12 According to at Least One Embodiment)

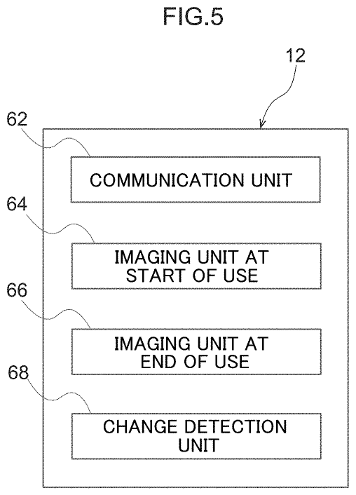

The vehicle interior detection device 12 included in the vehicle interior detection system 10 realizes various functions using the above hardware resources. The functional structures that are realized by the vehicle interior detection device 12 are explained with reference to FIG. 5.

As shown in FIG. 5, the vehicle interior detection device 12 is configured to include a communication unit 62, an imaging unit 64 at the start of use, an imaging unit 66 at the end of use, and a change detection unit 68 as functional components. These respective functional structures are realized by the CPU 30 reading-out and executing programs that are recorded in the ROM 32 and the storage 36.

The communication unit 62 receives a signal indicating the start of use and end of use of the vehicle V. For example, a signal for releasing the door lock of the vehicle V may be set as a signal for starting use of the vehicle V. In this case, when the user releases the door lock of the vehicle V, the communication unit 62 receives a signal indicating the start of use of the vehicle V. Further, for example, a signal at the time of power-on may be set as a signal to start using the vehicle V. In this case, the communication unit 62 receives a signal indicating the start of use of the vehicle V when the user gets into the vehicle V and directly powers on the vehicle V or remotely turns on the vehicle V.

Further, for example, a signal for locking the door of the vehicle V when the vehicle V has arrived at the destination may be set as a signal indicating the end of use of the vehicle V. In this case, by arriving at the preset destination and locking the door after the user gets off the vehicle V, the communication unit 62 receives a signal indicating the end of use of the vehicle V. Further, for example, a signal at the time of power-off may be set as a signal indicating the end use the vehicle V. In this case, by the user directly powering off the vehicle V, or remotely powering off the vehicle V after getting off the vehicle V, after having finished driving, the communication unit 62 receives a signal indicating the end of use of the vehicle V.

The use start-time imaging unit 64 captures an image of the entire vehicle cabin when the use of the vehicle V is started. Specifically, when the communication unit 62 receives a signal indicating the start of use of the vehicle V, the indoor camera 26 is used to image the entire vehicle interior. The captured image data of the vehicle interior is transmitted from the vehicle interior detection device 12 to the server 16 via the network 18 by the communication interface 38.

The end-of-use imaging unit 66 captures an image of the entire vehicle cabin when the use of the vehicle V ends. Specifically, when the communication unit 62 receives a signal indicating the end of use of the vehicle V, the indoor camera 26 is used to image the entire vehicle interior. The captured image data of the vehicle interior is transmitted from the vehicle interior detection device 12 to the server 16 via the network 18 by the communication interface 38, in the same manner as at the start of use.

The change detection unit 68 compares the image data of the vehicle interior imaged by the image capturing unit 64 at the start of use with the image data of the vehicle interior imaged by the image capturing unit 66 at the end of use, to thereby detect whether a change in at least one of scratches and dirt in the vehicle compartment due to use of the vehicle V. Specifically, when the use of the vehicle V by the user is completed, the image of the vehicle interior at the start of use stored in the server 16 is compared with the image of the vehicle interior at the end of use. Then, by extracting and analyzing the changed portion from both images, a determination is made regarding whether or not there is a newly damaged place. In a similar manner, a determination is made regarding whether or not there is a newly soiled place. Then, the communication unit 62 transmits, to the server 16, information on the change in the scratch and dirt in the vehicle cabin detected by the change detection unit 68.

Further, the change detection unit 68 detects a left-behind object in the vehicle interior by comparing the image of the vehicle interior at the start of use with the image of the vehicle interior at the end of use. When a lost object is detected by the change detecting unit 68, image data of the lost object is transmitted from the vehicle interior detecting device 12 to the server 16 via the network 18 by the communication interface 38.

(Functional Configuration of Reservation Device 14 According to at Least One Embodiment)

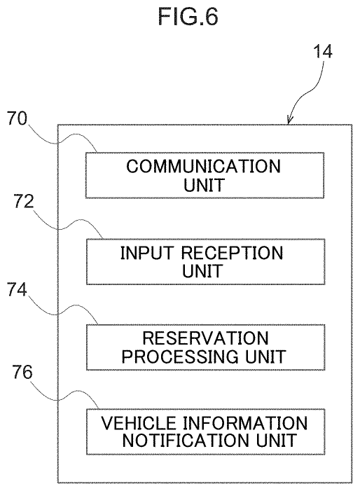

The reservation device 14 included in the vehicle interior detection system 10 realizes various functions using the above hardware resources. The functional configuration that is realized by the reservation device 14 is explained with reference to FIG. 6.

As shown in FIG. 6, the reservation device 14 is configured to include a communication unit 70, an input reception unit 72, a reservation processing unit 74, and a vehicle information notification unit 76 as functional components.

The communication unit 70 communicates with the vehicle interior detection device 12 and the server 16 via the network 18 by the communication interface 54. For example, the communication unit 70 receives information accumulated in the server 16 via the network 18. In addition, the communication unit 70 transmits information regarding the reservation to the vehicle V including the vehicle interior detection device 12 via the network 18.

The input receiving unit 72 receives information input by the user using the input device 60. When a ride reservation is made by the user, the reservation processing unit 74 accepts this reservation and transmits the reservation information to the vehicle V or the server 16.

The vehicle information notification unit 76 causes the monitor 58 to display vehicle information. For example, the information is notified to the user by displaying a list of available vehicles and information on scratches and dirt in the vehicle interior of each vehicle. At this time, the information on the scratches and dirt in the vehicle compartment of each vehicle is information on the change of the scratches and dirt in the vehicle compartment detected by the function of the change detection unit 68 of the vehicle interior detection device 12 and accumulated in the server 16.

(Operation)

Operation of at least one embodiment is described next.

(Example of Change Detection Processing)

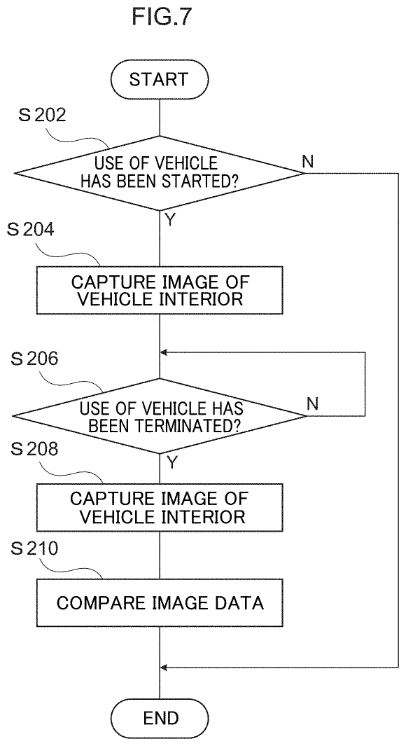

FIG. 7 is a flowchart of the flow of a change detection process by the vehicle interior detection system 10 according to at least one embodiment. This change detection processing is executed by the CPU 30 reading out a change detection program from the ROM 32 or the storage 36, outputting the program to the RAM 34, and executing the program. Further, the change detection processing is periodically executed at a predetermined time interval.

As shown in FIG. 7, the CPU 30 determines in step S202 whether or not the use of the vehicle V has been started. Specifically, the CPU 30 determines that the use of the vehicle V has been started when the signal of the start of use of the vehicle V is received by the function of the communication unit 62.

When determining in step S202 that the use of the vehicle V has been started, the CPU 30 proceeds to the process of Step S204. If the CPU 30 determines in step S202 that the use of the vehicle V has not been started, that is, if the vehicle V is in a state before use, the change detection process is ended.

The CPU 30 takes an image of the vehicle interior in step S204. Specifically, the CPU 30 captures an image of the vehicle interior using the indoor camera 26 by the function of the use start-time imaging unit 64. In at least one embodiment, since the camera is an omnidirectional camera, the entire interior of the vehicle can be imaged with a single imaging, but the invention is not limited to this. For example, image data of the entire vehicle cabin may be obtained by taking a plurality of images using a movable camera.

Next, the CPU 30 determines in step S206 whether or not the use of the vehicle V has been terminated. Specifically, by the function of the communication unit 62, a determination is made that the use of the vehicle V has been ended when the signal of the end of use of the vehicle V is received.

In response to the determination in step S206 that the use of the vehicle V has been ended, the CPU 30 proceeds to the process of Step S208. If the CPU 30 determines in step S206 that the use of the vehicle V has not been completed, that is, if the vehicle V is in the use state, the process of step S206 is repeated until the use is completed.

The CPU 30 takes an image of the vehicle interior in step S208. Specifically, the CPU 30 captures an image of the vehicle interior using the indoor camera 26 by the function of the use end-time imaging unit 66. For this reason, the image data of the vehicle cabin imaged by the function of the image capturing unit 66 at the end of use is image data captured at the same angle from the same position as the image data captured by the function of the image capturing unit 64 at the start of use.

Finally, the CPU 30 compares the image data in step S210. Specifically, the image data of the vehicle interior imaged by the image capturing unit 64 at the start of use is compared with the image data of the vehicle interior imaged by the image capturing unit 66 at the end of use by the function of the change detection unit 68, to thereby detect a change in scratches and dirt in the vehicle compartment due to use of the vehicle V. Information on the scratches and dirt is transmitted to the server 16. Then, the change detection processing ends.

Further, the CPU 30 detects a forgotten object in the vehicle compartment by comparing the image data. When a forgotten object is detected, information such as image data of the forgotten object is transmitted to the server 16.

As described above, in at least one embodiment, information on scratches and dirt generated during use of the vehicle V can be obtained. In addition, a person, such as a user, is not required to take an image of the vehicle interior, the image of the vehicle interior can be reliably taken at the start of use and at the end of use. As a result, stably confirming the presence or absence of flaws, dirt, and the like generated during use of the vehicle V is possible.

Further, in at least one embodiment, when a user forgets an object in a vehicle V or the like used in a car sharing service or the like, the change detector 68 can detect the lost object.

Further, in at least one embodiment, information on changes in the scratches and dirt in the vehicle compartment is accumulated in the server 16. As a result, information on the scratches and dirt on the vehicle V can be obtained by another device through the network 18.

In particular, by displaying information such as scratches and dirt in the vehicle cabin on the monitor 58 of the reservation device 14, the user can grasp the state of the vehicle cabin in advance, and the occurrence of troubles can be suppressed.

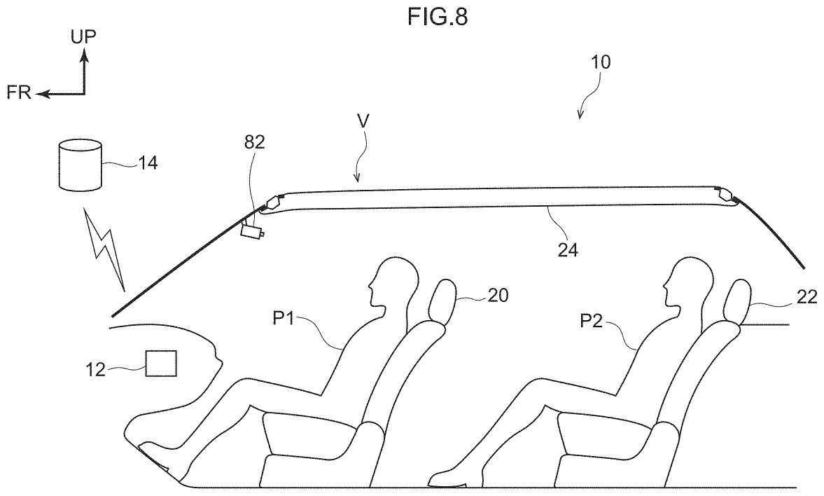

In the above embodiment, the indoor camera 26 is provided on the ceiling portion 24 in the vehicle interior, and the entire interior of the vehicle is imaged by the indoor camera 26, but the invention is not limited to this. For example, the structure of at least one embodiment shown in FIG. 8 may be adopted.

As shown in FIG. 8, in at least one embodiment, a driver monitor camera 82 is provided instead of the indoor camera 26.

The driver monitor camera 82 is provided at the front of the vehicle in the vehicle interior, and is configured to capture an image of the vehicle interior including the driver during driving. The driver is monitored by the driver monitor camera 82, and a warning is issued when the driver's arousal level decreases or when the driver is driving inattentively.

In at least one embodiment, the use start-time imaging unit 64 uses the driver monitor camera 82 to take an image of the entire vehicle compartment at the start of use of the vehicle V. The end-of-use imaging unit 66 uses the driver monitor camera 82 to image the entire interior of the vehicle when the use of the vehicle V ends. At this time, the image may be taken while changing the angle of the driver monitor camera 82 according to a preset program.

As described above, in at least one embodiment, the driver monitor camera 82 for capturing an image of a driver during driving is used to capture images of the vehicle interior at the start of use and at the end of use, and thereby there is no need to separately prepare a dedicated camera for performing the detecting of scratches and dirt in the vehicle interior.

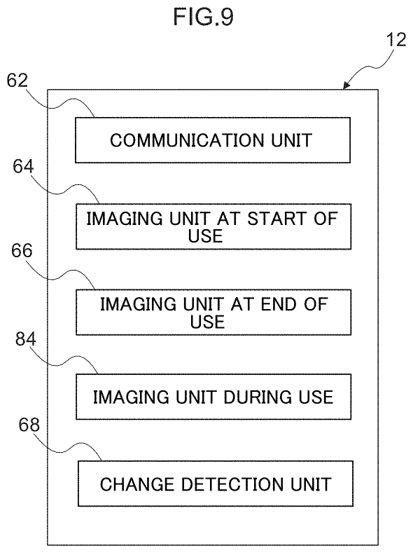

Further, in at least one embodiment, the image data of the vehicle interior imaged by the image capturing unit 64 at the start of use and the image data of the vehicle interior imaged by the image capturing unit 66 at the end of use are compared to detect a change in scratches and dirt in the vehicle interior due to use of the vehicle V; however the present disclosure is not limited to this. For example, the structure of the second modified example shown in FIG. 9 may be adopted.

As shown in FIG. 9, the vehicle interior detection device 12 according to at least one embodiment is configured to include a communication unit 62, an imaging unit 64 at the start of use, an imaging unit 66 at the end of use, during-use imaging unit 84, and a change detection unit 68 as functional components. These respective functional structures are realized by the CPU 30 reading-out and executing programs that are recorded in the ROM 32 and the storage 36.

Here, the in-use imaging unit 84 takes an image of the entire vehicle interior using the indoor camera 26 from when the use of the vehicle V is started to when the use is completed. The captured image data of the vehicle interior is transmitted from the vehicle interior detection device 12 to the server 16 via the network 18 by the communication interface 38. Note that the in-use imaging unit 84 captures an image of the vehicle interior at regular intervals from when the communication unit 62 receives the signal indicating the start of use of the vehicle V to when the signal indicating end of use of the vehicle V is received.

The change detection unit 68 compares the image data of the vehicle interior imaged by the image capturing unit 64 at the start of use with the image data of the vehicle interior imaged by the image capturing unit 66 at the end of use, to thereby detect whether a change in at least one of scratches and dirt in the vehicle compartment due to use of the vehicle V. Further, the change detection unit 68 compares the image data of the vehicle interior imaged by the image capturing unit 64 at the start of use with the image data of the vehicle interior imaged by the during-use image capturing unit 84, to thereby detect whether a change in at least one of scratches and dirt in the vehicle compartment due to use of the vehicle V.

As described above, in at least one embodiment, the in-use image capturing unit 84 captures an image of the vehicle interior even during use of the vehicle. This makes accurately obtaining information on at least one of scratches and dirt generated during use of the vehicle V possible. In other words, even if determining the flaws caused during use of the vehicle V from the image data of the inside of the vehicle taken by the imaging unit 66 at the end of use is not possible, determining flaws caused during used of the vehicle V from images of the inside of the vehicle taken by the in-use imaging unit 84 is possible. In particular, by imaging the vehicle interior at regular intervals, detecting scratches and dirt based on more image data is possible.

Although explanation has been given regarding at least one embodiment, obviously various modifications are possible within a range not departing from the spirit of the present disclosure. For example, in the at least one embodiment, although the function of the change detection unit 68 detects a change in the scratch and dirt in the vehicle compartment due to the use of the vehicle V, the present disclosure is not limited to this and may be configured to detect only scratches in the vehicle interior. Further, only the dirt in the vehicle compartment may be detected by the function of the change detection unit 68. That is, any configuration may be used as long as the change detection unit 68 detects at least one of scratches and dirt in the vehicle compartment.

In at least one embodiment, the interior of the vehicle is imaged using the indoor camera 26, and in at least one embodiment, the interior of the vehicle is imaged using the driver monitor camera 82; however, these may be combined. That is, at the start of use and at the end of use, both the indoor camera 26 and the driver monitor camera 82 may capture an image of the vehicle interior and transmit two image data to the server 16. Further, another imaging device may be used.

Further, in addition to the above-described at least one embodiment, sensors such as an odor sensor may be mounted, and dirt may be detected based on information obtained from these sensors. For example, even when a stain occurs in a blind spot from the indoor camera 26, the sanitary condition in the vehicle compartment can be detected based on information from the odor sensor.

Moreover, the change detection processing that is executed by the CPU 30 reading software such as a programs in the above at least one embodiment may be executed by various processors other than a CPU. Examples of such processors include a PLD that is a Programmable Logic Device, in which circuit configuration can be modified post-manufacture, such as a FPGA, that is, a Field-Programmable Gate Array, or a specialized electric circuit that is a processor with a specifically-designed circuit configuration for executing specific processing, such as an ASIC, that is an Application Specific Integrated Circuit. Further, the change detection processing may be executed by one of these various types of processors, or may be executed by combining two or more of the same type or different types of processors, for example, plurals FPGAs, or a combination of a CPU and an FPGA, or the like. More specific examples of hardware structures of such processors include electric circuits configured by combining circuit elements such as semiconductor devices.

Further, in at least one embodiment, the ROM 32 or the storage 36 and the ROM 48 or the storage 52 are memories, but the present disclosure is not limited to this. For example, a non-transitory storage medium such as a CD, that is, a Compact Disk, a DVD, that is, a Digital Versatile Disk, and a USB, that is, a Universal Serial Bus, may be used as the memory. In this case, various programs are stored in these non-temporary storage media.

What is claimed is:

1. A vehicle interior detection device, comprising:
a memory; and
a processor connected to the memory, wherein the processor is configured to:
receive a first signal at a start-of-use of a vehicle;
receive a second signal at an end-of-use of the vehicle;
capture a first image of an interior of the vehicle in response to receiving the first signal;
capture a second image of the interior of the vehicle in response to receiving the second signal; and
detect at least one of damage in the interior of the vehicle or a blemish in the interior of the vehicle by comparing image data of the first image with image data of the second image.

2. The vehicle interior detection device according to claim 1, wherein the processor is configured to detect an item left behind in the interior of the vehicle.

3. The vehicle interior detection device according to claim 1, wherein the processor is configured to cause a camera to capture the first image of the interior of the vehicle in response to receiving the first signal, and to cause the camera to capture the second image in response to receiving the second signal.

4. The vehicle interior detection device according to claim 1, wherein the processor is configured to cause a driver monitoring camera to capture the first image of the interior of the vehicle including a driver in response to receiving the first signal, and to capture the second image of the interior of the vehicle including the driver in response to receiving the second signal.

5. The vehicle interior detection device according to claim 1, wherein the processor is configured to:
cause a camera to capture an in-use image of the interior of the vehicle during use, wherein use is a period between receipt of the first signal and receipt of the second signal; and
detect the at least one of damage in the interior of the vehicle or the blemish in the interior of the vehicle by comparing the image data of the first image with the image data of the second image, and by comparing the image data of the first image with image data of the in-use image.

6. The vehicle interior detection device according to claim 1, wherein the processor is configured to transmit, via a network, information regarding a change in the at least one of the damage detected in the interior of the vehicle or the blemish detected in the interior of the vehicle to a server.

7. The vehicle interior detection device according to claim 6, wherein the processor is configured to notify a user of the information regarding the change in the at least one of the damage detected in the interior of the vehicle or the blemish detected in the interior of the vehicle by a reservation device that is configured to transmit, via the server, a signal of a ride reservation to the vehicle.

8. A vehicle interior detection method, the method comprising, by a processor:
receiving a first signal at a start-of-use of a vehicle;
receiving a second signal at an end-of-use of the vehicle;
capturing a first image of an interior of the vehicle in response to receiving the first signal;
capturing a second image of the interior of the vehicle in response to receiving the second signal; and
detecting at least one of damage in the interior of the vehicle or a blemish in the interior of the vehicle by comparing image data of the first image with image data of the second image.

9. The vehicle interior detection method according to claim 8, the method comprising detecting an item left behind in the interior of the vehicle based on the comparison of the image data of the first image with the image data of the second image.

10. The vehicle interior detection method according to claim 8, further comprising:
causing a camera to capture the first image in response to receiving the first signal; and
causing the camera to capture the second image in response to receiving the second signal.

11. The vehicle interior detection method according to claim 8, further comprising:
causing a driver monitoring camera to capture the first image of the vehicle interior including a driver in response to receiving the first signal; and
causing the driver monitoring camera to capture the second image of the vehicle interior including the driver in response to receiving the second signal.

12. The vehicle interior detection method according to claim 8, further comprising:
causing a camera to capture an in-use image of the interior of the vehicle during use, wherein use is a time period between receipt of the first signal and receipt of the second signal; and
detecting the at least one of the damage in the interior of the vehicle or the blemish in the interior of the vehicle by comparing the image data of the first image with the image data of the second image, and by comparing the image data of the first image with image data of the in-use image.

13. The vehicle interior detection method according to claim 8, further comprising transmitting, via a network, information regarding a change in the at least one of the damage detected in the interior of the vehicle or the blemish detected in the interior of the vehicle to a server.

14. The vehicle interior detection method according to claim 13, further comprising notifying a user of the information regarding the change in the at least one of the damage detected in the interior of the vehicle or the blemish detected in the interior of the vehicle.

15. A non-transitory storage medium that stores instructions that cause a processor to execute vehicle interior detection processing, the processing including:
receiving a first signal at a start-of-use of a vehicle;
receiving a second signal at an end-of-use of the vehicle;
capturing a first image of an interior of the vehicle in response to receiving the first signal;
capturing a second image of the interior of the vehicle in response to receiving the second signal; and
detecting at least one of damage in the interior of the vehicle or a blemish in the interior of the vehicle by comparing image data of the first image with image data of the second image.

16. The non-transitory storage medium according to claim 15, wherein the processing further comprises:
causing a camera to capture the first image in response to receiving the first signal; and
causing the camera to capture the second image in response to receiving the second signal.

17. The non-transitory storage medium according to claim 15, wherein the processing further comprises:
causing a driver monitoring camera to capture the first image of the vehicle interior including a driver in response to receiving the first signal; and
causing the driver monitoring camera to capture the second image of the vehicle interior including the driver in response to receiving the second signal.

18. The non-transitory storage medium according to claim 15, wherein the processing further comprises:
causing a camera to capture an in-use image of the interior of the vehicle during use, wherein use is a time period between receipt of the first signal and receipt of the second signal; and
detecting the at least one of the damage in the interior of the vehicle or the blemish in the interior of the vehicle by comparing the image data of the first image with the image data of the second image, and by comparing the image data of the first image with image data of the in-use image.

19. The non-transitory storage medium according to claim 15, wherein the processing further comprises transmitting, via a network, information regarding a change in the at least one of the damage detected in the interior of the vehicle or the blemish detected in the interior of the vehicle to a server.

20. The non-transitory storage medium according to claim 19, wherein the processing further comprises notifying a user of the information regarding the change in the at least one of the damage detected in the interior of the vehicle or the blemish detected in the interior of the vehicle.
